(19) United States
(12) Patent Application Publication
(10) Pub. No.: US 2004/0212604 A1
(43) Pub. Date: Oct. 28, 2004

(54) Device and method for providing a reminder signal

(76) Inventor: Dee Nai Ong, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/420,552

(22) Filed: Apr. 22, 2003

(51) Int. Cl. G09G 5/00

(52) U.S. Cl. 345/179

(57) ABSTRACT

An electronic device (1) has an interactive display screen (5) that is interactive with a stylus (10). The electronic device (1) has a switch (30) associated with a stylus engagement member (20) of a housing (2) of the device (1) and the switch (30) is actuated when the stylus (10) is stored in the engagement member (20). The device (1) has an alarm (39) coupled to a controller (32). When the controller (32) determines that the display screen (5) should power down and the switch (30) provides a detection signal indicative of the stylus (10) being disengaged from the stylus engagement member (20), then the alarm (39) provides a reminder signal to insert the stylus (10) into the stylus engagement member (20).

### FIELD OF THE INVENTION

This invention relates to an electronic device having an interactive display screen and a stylus engagement member facilitating storage of a stylus for interacting with the screen. More specifically, the invention provides a reminder signal when the stylus has not been inserted into the engagement member and the device powers down or goes into a screen lock or power saving mode.

### BACKGROUND ART

Electronic devices such as personal organisers and portable communication devices sometimes use an interactive display screen, usually called a touch screen, to allow a user to input data or access functions. In order to achieve a higher resolution than that obtained by use of a finger, some electronic devices have an associated stylus for selecting Icons or scribing on the interactive display screen. Furthermore, for convenience the stylus is usually stored in a stylus engagement member, typically an aperture, in a housing of the electronic device.

In U.S. Pat. No. 5,973,677, there is disclosed a rechargeable stylus and portable device assembly with an interactive display. The stylus is recharged when inserted into an engagement member in the housing where it is coupled to recharging electrical pads. When using a stylus with a portable communication device, a user typically has the stylus in one hand and the communication device in the other. This may not be ideal as the user may have difficulties in powering down, powering up or inactivating illumination of the display screen by use of a convention button. In U.S. patent application Ser. No. 09/694,441 there is described an electronic device with a stylus engagement member in the device's housing. The device powers up and powers down by respectively detecting insertion and removal of a stylus from the stylus engagement member. However, if the device powers down by operation of a conventional key operation or screen lock or power saving mode occurs, then the stylus may be accidentally discarded or misplaced. Furthermore, other electronic devices also typically suffer stylus loss or misplacement. It would therefore be useful if such devices provided a reminder signal to remind a user to store the stylus in the stylus engagement member of the device.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided an electronic device comprising:

a controller;

an interactive display screen coupled to said controller;

a housing having a stylus engagement member for releasably engaging a stylus to allow mounting of the stylus to the housing;

a stylus detector associated with the stylus engagement member, said stylus detector being coupled to said controller; and

an alarm coupled to said controller, wherein in use, when the controller determines that the display screen should at least partially power down and the stylus detector provides a detection signal indicative of the stylus being disengaged from the stylus engagement member, then the alarm provides a reminder signal to insert the stylus into the stylus engagement member.

Preferably, in use, the device provides for the reminder signal terminating when the stylus is inserted into said stylus engagement member.

Suitably, the stylus detector may be a biased switch.

Preferably, the biased switch may have a protruding member that protrudes into a stylus receiving chamber of the stylus engagement member.

Suitably, the alarm emits an audible signal. In one alternative form, the alarm may provide a tactile signal. In yet another form, the alarm may provide a visual signal.

Preferably, the alarm may be provided for a pre-defined period.

Alternatively, according to another aspect of the invention there is provided a method for proving a reminder signal from an electronic device, the method being performed by the device and the method comprising:

Receiving a display screen power down signal for an interactive display screen of the electronic device, the power down signal at least partially reducing power consumption to the display screen;

Determining if the stylus is disengaged from a stylus engagement member of the device; and

Providing a reminder signal to insert the stylus into the stylus engagement member when the stylus is disengaged from the stylus engagement member.

Suitably, the method may be further characterised by the reminder signal terminating when the stylus is inserted into said stylus engagement member.

Preferably, the alarm may be provided for a pre-defined period.

### BRIEF DESCRIPTION OF THE DRAWINGS

In order that the invention may be readily understood and put into practical effect, reference will now be made to preferred embodiment illustrated in the accompanying drawings in which:

FIG. 1 is a top perspective view illustrating an electronic device in accordance with an embodiment of the invention;

FIG. 2 is an underside perspective view of the electronic device of FIG. 1 with a stylus engaging a stylus engagement member in a housing of the electronic device;

FIG. 3 is an electrical schematic block diagram of circuitry of a first preferred embodiment of the electronic device of FIG. 1;

FIG. 4 is an electrical schematic diagram of circuitry of a second preferred embodiment of the electronic device of FIG. 1; and

FIG. 5 is a flow diagram illustrating a method for providing a reminder signal, the method being typically used by the electronic device of FIG. 1.

### DETAILED DESCRIPTION OF THE PREFERRED EMBODIMENTS OF THE INVENTION

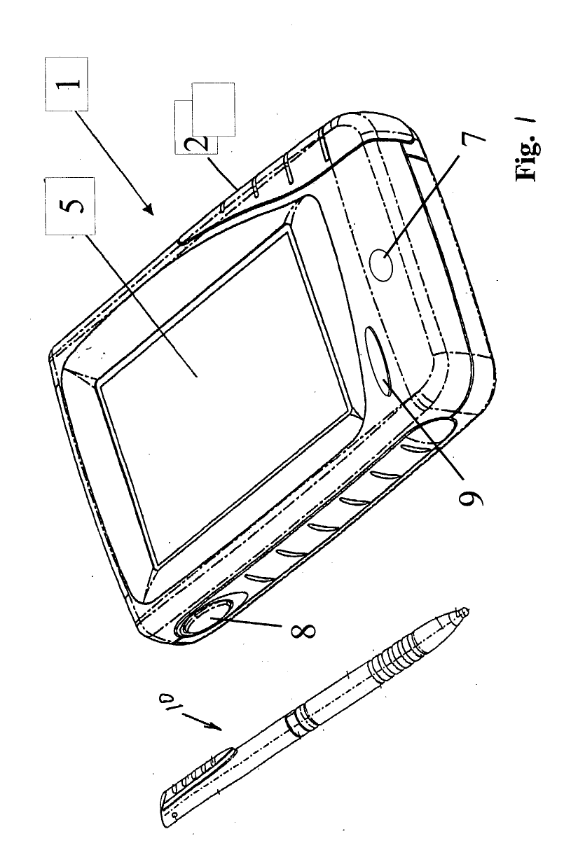

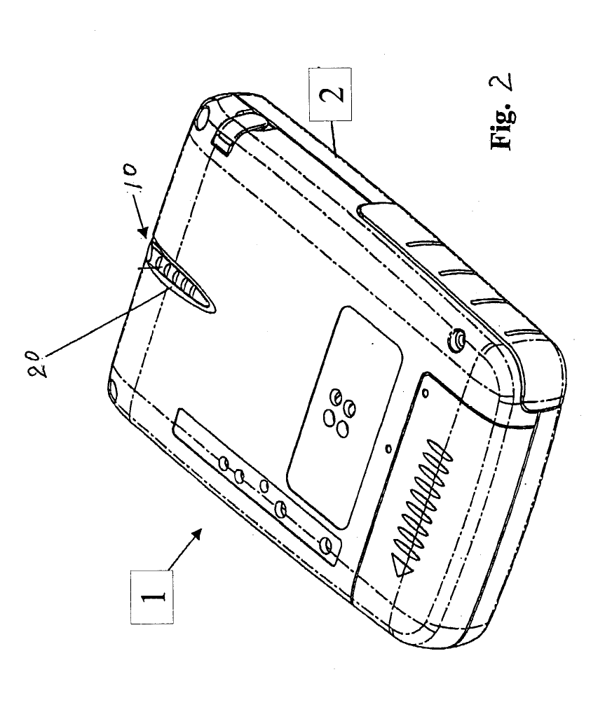

Referring to the Figs. in which like components are designated by identical numerals, reference is first directed to FIGS. 1 and 2 which illustrate an electronic device 1 such as personal organiser or radio communication device. The electronic device 1 comprises a housing 2 and an interactive display screen 5. The interactive display screen 5 is often known as a touch screen and provides an interface to allow commands to be input into the electronic device 1 by a user. There is also a stylus 10 and FIG. 2 shows the stylus 10 fully engaging (completely inserted) with a stylus engagement member 20 of the electronic device 1. The stylus 10 is provided for interaction with the interactive display screen 5 and allows the user to input commands and select icons with higher resolution that of using one of their fingers. For instance, in use the stylus 10 interacts with the interactive display screen 5 for selecting functions, accessing data, selecting alphanumeric keys, freehand writing and drawing that is processed by the electronic device 1. The stylus engagement member 2, in the housing 2, provides for releasable engagement of the stylus 10 (by insertion) thereby allowing for convenient storing (mounting) of the stylus 10 in the housing 2. In this regard, the engagement member 20 can be wholly integrated as a storage chamber (cavity) within the housing 2 or mounted on the housing 2 in the form of a clip.

The electronic device 1 also has an alarm aperture 7 allowing an audible reminder signal to be emitted, without significant attenuation due to the housing 2, from an alarm contained inside the housing 2. There is also a push button 8 on a side of the housing for power up and power down and power saving mode control operations. Also, on the housing is a push button 9 for manually terminating a reminder signal as will be described later.

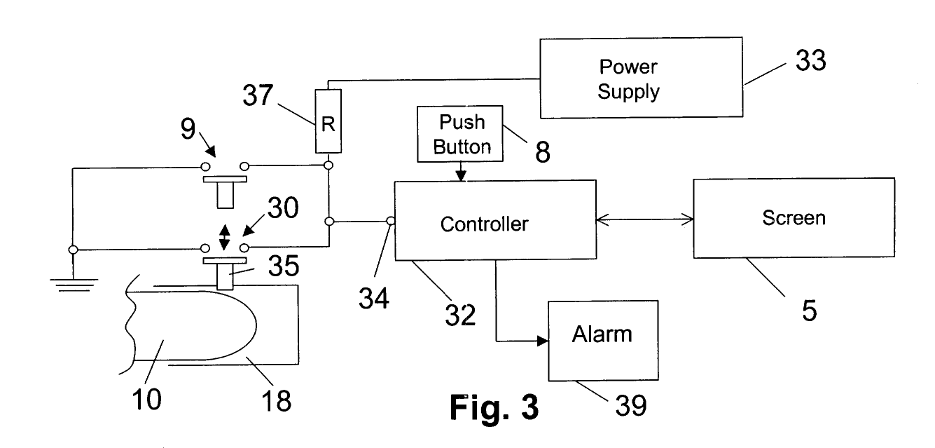

Referring to FIG. 3, there is illustrated a preferred embodiment of a schematic diagram of circuitry of the electronic device 1. The interactive display screen 5 is coupled to a controller 32 to send information, message data and instructions to each other. The electronic device 1 also comprises a stylus detector in the form of a biased switch 30 associated with a stylus receiving chamber 18 of the engagement member 20. The switch 30 is normally open and has one contact coupled to ground and one contact coupled to a control input 34 of the controller 32 to provide a stylus detection signal. There is also a power supply 33 coupled to the controller 32 and all the necessary components in the circuitry of the device 1. A pull up resistor 37 is also coupled to control input 34 for maintaining control input 34 to logic “high” until switch 30 is activated.

The switch 30 has a protruding member 35 that protrudes into the stylus receiving chamber 18. The protruding member 35 activates the switch 30 (electrically connecting contacts of switch 30) when the stylus 10 is inserted (at least partially) into the stylus receiving chamber 18 thereby engaging engagement member 20. Conversely, the protruding member 35 inactivates the switch 30 (contacts of switch 30 become an open circuit) when the stylus 10 is removed from engagement member 20. When the contacts of the switch 30 are electrically isolated or open circuit, the stylus detection signal indicative of the stylus 10 disengaging the engagement member 20 is provided to the controller 32. When the stylus 10 is inserted into the receiving chamber 18 the contacts of switch 30 are electrically connected (closed) and the stylus detection signal is provided to the controller 32 indicative of the stylus 10 engaging the engagement member 20. The push button 8 and an alarm 39 are also coupled to the controller 33, the alarm 39 being located adjacent the alarm aperture 7. Furthermore, the push button 9 (with normally open contacts) is connected in parallel with the biased switch 30.

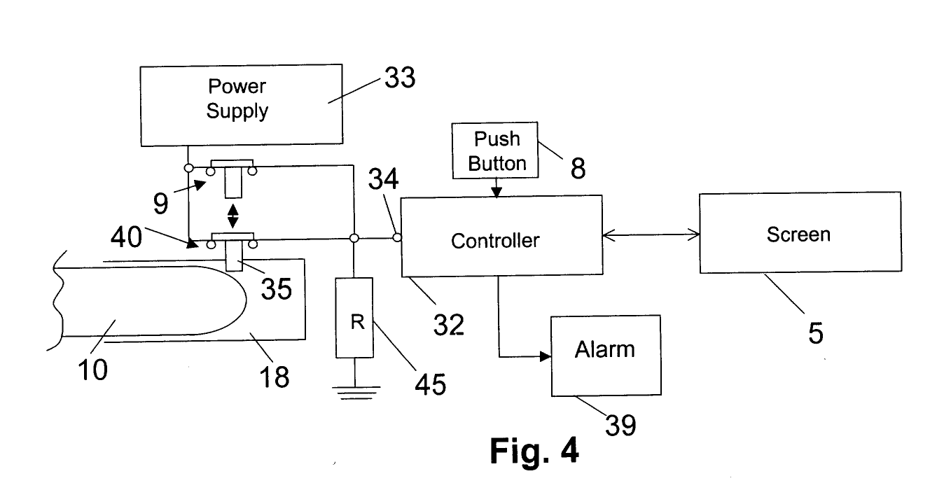

Referring to FIG. 4, there is illustrated a second preferred embodiment of a schematic diagram of circuitry of the electronic device 1. The circuitry has a normally closed switch 40 with two electrical contacts. One of the contacts is coupled to the power supply 33 and the other contact is coupled to control input 34 of the controller 32. A pull down resistor 45 is also coupled to control input 34. Furthermore, the push button 9 (with normally closed contacts) is connected in parallel with the biased switch 40. All other components are configured identically to those of FIG. 3 and therefore require no further description.

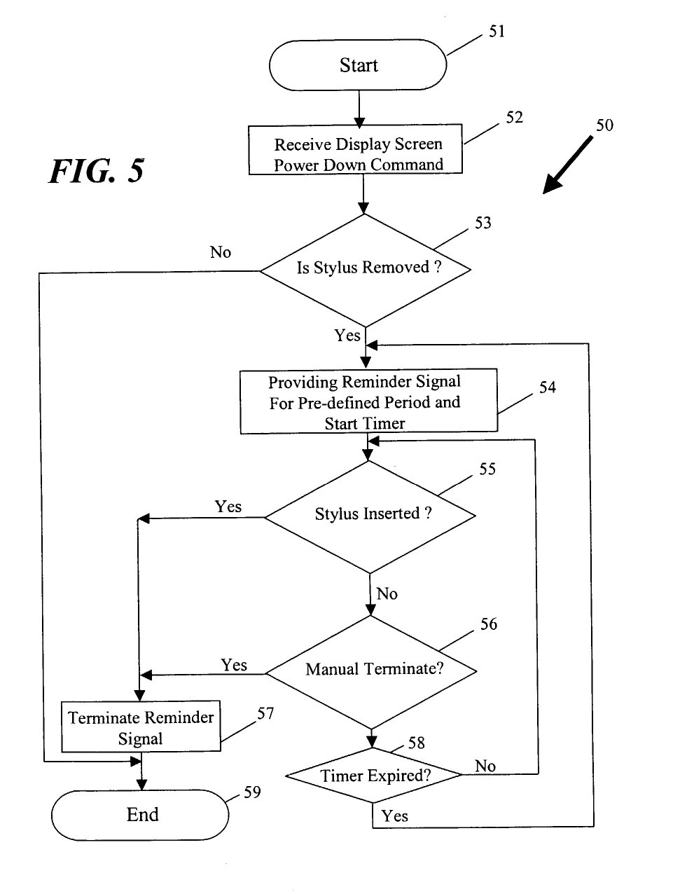

In use, and referring to FIG. 5, there is illustrated a method 50 for providing a reminder signal. The method 50, after a start step 51, receives a display screen power down command (or signal) 52, this is typically effected by activation of the push button 8, or by the controller 32 determining that power down is required as will be apparent to a person skilled in the art. In this regard, power down may be a screen saver or screen lock command therefore partially reducing power consumption to the display screen 5. However, power down may be a total power down command that removes power from the display 5. After the power down command 52 is received, a test 53 determines if the stylus 10 is removed from the chamber 18 of the stylus engagement member 20 by the controller analysing the stylus detection signal that is controlled by the stylus detector (biased switch 30 or 40). If the stylus detection signal indicates that the stylus is inserted into the chamber 18 of the stylus engagement member 20 then the method ends at step 59. Alternatively, if the stylus detection signal indicates that the stylus 10 is removed from the stylus engagement member 20 then the method effects a providing a reminder signal step 54 by the controller 32 sending an alerting signal to the alarm 39 to emit an audible reminder signal. The controller 32 controls the alarm 39 to emit the reminder signal for a pre-defined period (for instance five seconds) and the controller 32 also initiates a start timer Ts upon sending the alerting signal to the alarm 39.

A test 55 then determines if the stylus 10 has been inserted into the stylus engagement member 20 thereby closing contacts of the switch 30 of FIG. 3 (or opening contacts of switch 40 in FIG. 4) and signalling the controller 32 with the stylus detection signal. If the stylus 10 has been inserted then the controller 32 terminates the reminder signal at step 57 and the method then ends 59. Alternatively, if controller 32 at test 55 determines that the stylus has not been inserted then the controller may still terminate the reminder signal 57 if at a test 56 a user activates the push button 9. However, if the push button 9 is not activated then a test 58 determines if the start timer Ts has expired. If the start timer TS has not expired then the method 50 returns to test step 55, however, if the start timer has expired then the method 50 returns to step 54 and another reminder signal is emitted by alarm 39.

Advantageously, the present invention allows for the device 1 to provide a reminder signal that reminds a user to store the stylus 10 in the stylus engagement member 20 of the device 1. This therefore alleviates the problem or accidental discarding or misplacement of the stylus 10. Also, as will be apparent to a person skill in the art, although the stylus detector as illustrated is the biased switch 30, the stylus detector may also be a capacitive, inductive or light sensing device. Similarly, the alarm 39 as described is an audio signal generator, however the alarm 39 may also be a tactile signal generator or visual signal generator.

The detailed description provides preferred exemplary embodiments only, and is not intended to limit the scope, applicability, or configuration of the invention. Rather, the detailed description of the preferred exemplary embodiments provide those skilled in the art with an enabling description for implementing preferred exemplary embodiments of the invention. It should be understood that various changes may be made in the function and arrangement of elements without departing from the spirit and scope of the invention as set forth in the appended claims.

We claim:

1. An electronic device comprising:
a controller;
an interactive display screen coupled to said controller;
a housing having a stylus engagement member for releasably engaging a stylus to allow mounting of the stylus to the housing;
a stylus detector associated with the stylus engagement member, said stylus detector being coupled to said controller; and
an alarm coupled to said controller, wherein in use, when the controller determines that the display screen should at least partially power down and the stylus detector provides a detection signal indicative of the stylus being disengaged from the stylus engagement member, then the alarm provides a reminder signal to insert the stylus into the stylus engagement member.

2. The electronic device, as claimed in claim 1, wherein in use the device provides for the reminder signal terminating when the stylus is inserted into said stylus engagement member.

3. The electronic device, as claimed in claim 1, wherein the stylus detector is a biased switch.

5. The electronic device, as claimed in claim 3, wherein the biased switch has a protruding member that protrudes into a stylus receiving chamber of the stylus engagement member.

6. The electronic device, as claimed on claim 1, wherein the alarm is provided for a pre-defined period.

7. A method for proving a reminder signal from an electronic device, the method being performed by the device and the method comprising:
Receiving a display screen power down signal for an interactive display screen of the electronic device, the power down signal at least partially reducing power consumption to the display screen;
Determining if the stylus is disengaged from a stylus engagement member of the device; and
Providing a reminder signal to insert the stylus into the stylus engagement member when the stylus is disengaged from the stylus engagement member.

8. A method for proving a reminder signal, as claimed in claim 7, wherein the reminder signal terminates when the stylus is inserted into said stylus engagement member.

9. A method for proving a reminder signal, as claimed in claim 7, wherein the alarm may be provided for a pre-defined period.
